(19) United States
(12) Patent Application Publication
(10) Pub. No.: US 2025/0253942 A1
(43) Pub. Date: Aug. 7, 2025

(54) OPTICAL FIBER TRANSMISSION CHANNEL AND OPTICAL TRANSMISSION METHOD

(71) Applicant: NEC Corporation, Tokyo (JP)

(72) Inventor: Yuushi MATSUO, Tokyo (JP)

(73) Assignee: NEC Corporation, Tokyo (JP)

(21) Appl. No.: 18/989,714

(22) Filed: Dec. 20, 2024

(30) Foreign Application Priority Data
Feb. 1, 2024 (JP) 2024-013862

(51) Int. Cl. H04B 10/071; H04B 10/27

(52) U.S. Cl. CPC H04B 10/071; H04B 10/27

(57) ABSTRACT

An optical fiber transmission channel includes: a first optical fiber configured to include a plurality of cores sharing a clad; a second optical fiber configured not to share a clad with the first optical fiber; and a first coupling circuit configured to couple a core of the first optical fiber to a core of the second optical fiber, wherein the coupling circuit couples return light of first light propagating through a core of the first optical fiber to a core of the second optical fiber as second light.

This application is based upon and claims the benefit of priority from Japanese patent application No. 2024-013862, filed on Feb. 1, 2024, the disclosure of which is incorporated herein in its entirety by reference.

### TECHNICAL FIELD

The present disclosure relates to an optical fiber transmission channel and the like.

### BACKGROUND ART

A multi-core fiber (MCF) accommodating a plurality of cores in one optical cable may be used in an optical transmission system for the purpose of efficiently accommodating rapidly increasing traffic demand. On the other hand, an optical time-domain reflectometer (OTDR) device is known as equipment for monitoring the state of an optical transmission The OTDR device is normally installed at a terminal station in system. an optical transmission system. The OTDR device can monitor an optical fiber transmission channel by transmitting monitoring light and measuring Rayleigh scattered light generated by the monitoring light. Cores of an MCF can be monitored one by one by changing a core to which monitoring light output from the OTDR device is input. In relation to the present disclosure, International Application Publication No. WO 2023/026486 describes a technology related to reduction of crosstalk (XT) in a multi-core optical fiber.

### SUMMARY

In an optical transmission system using an MCF (MCF transmission system), crosstalk being a leak of light propagating through one of adjacent cores into another core occurs. Crosstalk between cores includes parallel crosstalk and counter crosstalk. The parallel crosstalk is crosstalk between light beams propagating in the same direction between two cores. The counter crosstalk is crosstalk between light beams propagating in directions opposite to each other between two cores. Making a comparison between the magnitude of parallel crosstalk and the magnitude of counter crosstalk generally results in the magnitude of counter crosstalk being smaller. Therefore, counter transmission being a transmission method employing different directions of light beams propagating through two cores is often used for an FP and a CP in an MCF transmission system in order to suppress degradation in transmission performance caused by crosstalk.

However, when monitoring of an MCF is performed by using an OTDR, crosstalk light may be superposed on Rayleigh scattered light due to counter crosstalk by monitoring light. Since the crosstalk light is noise to Rayleigh scattered light in the OTDR, precision in a monitoring result in the OTDR may be degraded due to an effect of the counter crosstalk.

The present disclosure describes a technology for suppressing degradation in precision in monitoring of an optical fiber transmission channel caused by crosstalk.

An optical fiber transmission channel according to the present disclosure includes: a first optical fiber configured to include a plurality of cores sharing a clad; a second optical fiber configured not to share a clad with the first optical fiber; and a first coupling circuit configured to couple a core of the first optical fiber to a core of the second optical fiber, wherein the coupling circuit couples return light of first light propagating through a core of the first optical fiber to a core of the second optical fiber as second light.

An optical transmission method according to the present disclosure is an optical transmission method used in an optical fiber transmission system including: an optical fiber transmission channel; and an optical time-domain reflectometer (OTDR) device, wherein the optical fiber transmission channel includes: a first optical fiber configured to include a plurality of cores sharing a clad; a second optical fiber configured not to share a clad with the first optical fiber; and a first coupling circuit configured to couple a core of the first optical fiber to a core of the second optical fiber, the optical transmission method including a procedure for, by the coupling circuit, coupling return light of first light propagating through a core of the first optical fiber to a core of the second optical fiber as second light, and by the OTDR device, transmitting the first light to the first optical fiber and receiving the second light from the second optical fiber.

The technology according to the present disclosure can suppress degradation in precision in monitoring of an optical fiber transmission channel caused by crosstalk.

### BRIEF DESCRIPTION OF THE DRAWINGS

Exemplary features and advantages of the present invention will become apparent from the following detailed description when taken with the accompanying drawings in which:

FIG. 1 is a diagram illustrating a configuration example of an optical fiber transmission channel;

FIG. 2 is a diagram illustrating an example of a result of monitoring an optical fiber by using a common technology;

FIG. 3 is a diagram illustrating an example of a result of monitoring an optical fiber when an effect of inter-core crosstalk is small;

FIG. 4 is a diagram illustrating a configuration example of an optical fiber transmission channel;

FIG. 5 is a diagram illustrating a configuration example of an optical fiber transmission channel;

FIG. 6 is a diagram illustrating a configuration example of an optical fiber transmission channel;

FIG. 7 is a diagram illustrating a configuration example of an optical fiber transmission system;

FIG. 8 is a diagram illustrating an example of propagation of monitoring light and Rayleigh scattered light in the optical fiber transmission system;

FIG. 9 is a diagram illustrating an example of propagation of crosstalk light in the optical fiber transmission system;

FIG. 10 is a diagram illustrating a configuration example of an optical fiber transmission system;

FIG. 11 is a diagram illustrating a configuration example of an optical fiber transmission system; and

FIG. 12 is a diagram illustrating a common configuration for monitoring an optical fiber transmission channel.

### EXAMPLE EMBODIMENT

Example embodiments of the present disclosure will be described below with reference to drawings. In the example embodiments and the drawings, previously described components are given the same reference signs, and overlapping description thereof may be omitted. The direction and the width of an arrow in a diagram are not intended to limit the direction and the amplitude of a signal or the like. It is assumed that a multi-core fiber to be used in each example embodiment is an uncoupled multi-core fiber unless otherwise mentioned.

### First Example Embodiment

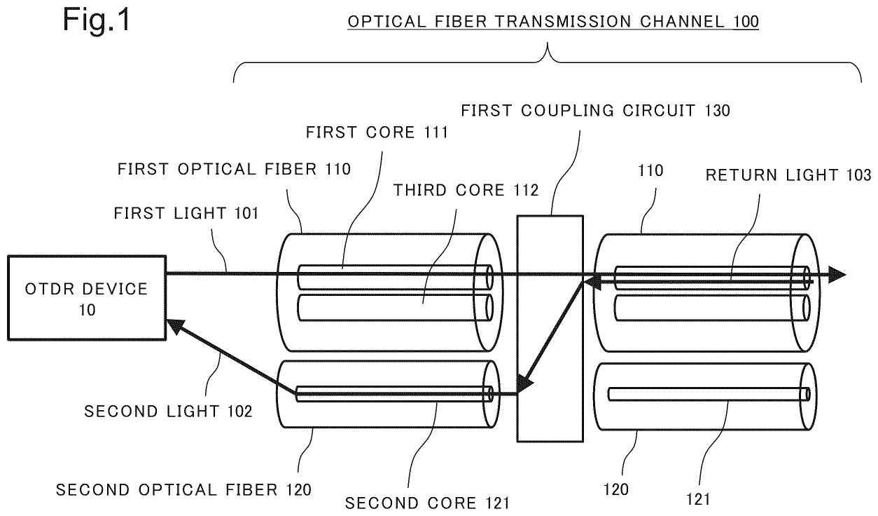

FIG. 1 is a diagram illustrating a configuration example of an optical fiber transmission channel 100 according to the present disclosure. The optical fiber transmission channel 100 includes a first optical fiber 110, a second optical fiber 120, and a first coupling circuit 130. The first optical fiber 110 and the second optical fiber 120 are different optical fibers. The first optical fiber 110 is an uncoupled multi-core fiber constituted of a plurality of cores sharing a clad and includes a first core 111. The second optical fiber 120 is an optical fiber not sharing a clad with the first optical fiber 110 and includes a second core 121. In FIG. 1, first light propagates through the first core 111 in a direction from the left-hand side to the right-hand side of the page. The first optical fiber 110 may include a third core 112. When the first optical fiber 110 is used as a transmission channel of signal light, a communication method for suppressing crosstalk between signal light beams between a plurality of cores in the first optical fiber 110 may be used. For example, the first optical fiber 110 may be configured to perform counter transmission by using the first core 111 and the third core 112. Specifically, the direction of signal light propagating through the first core 111 may be opposite to the direction of signal light propagating through the third core 112.

The first coupling circuit 130 is inserted in the middle of each of the first optical fiber 110 and the second optical fiber 120. The first coupling circuit 130 couples return light 103 to the second core 121 as second light 102. The return light 103 is light generated by first light 101 being backscattered or reflected, and the second light 102 and the return light 103 are light beams the propagation direction of which is opposite to the propagation direction of the first light 101 in the optical fiber transmission channel 100.

The optical fiber transmission channel 100 with such a configuration can suppress degradation in monitoring precision caused by inter-core crosstalk when the first optical fiber 110 is monitored by propagating the first light through the first core 111. The reason is that since the second core 121 is included in the second optical fiber 120 not sharing a clad with the first optical fiber 110, counter crosstalk between light propagating through the first optical fiber 110 and light propagating through the second core 121 is negligible.

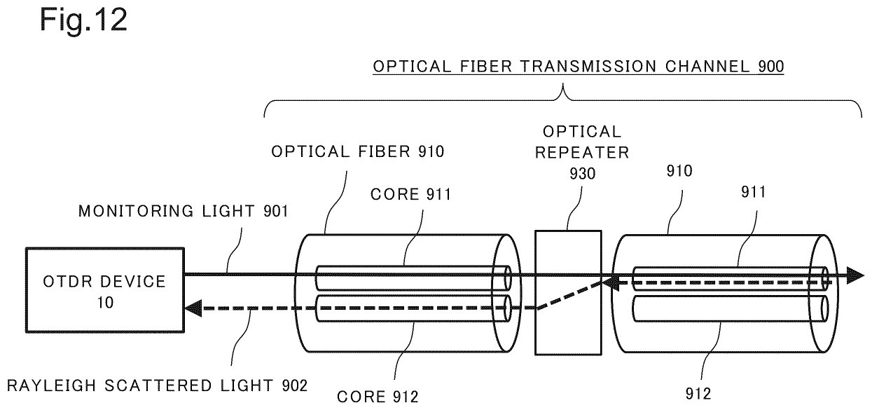

FIG. 12 is a diagram illustrating a common configuration for monitoring an optical fiber transmission channel 900 by using an OTDR device 10. A core 911 and a core 912 are included in the same optical fiber 910. Monitoring light 901 is input to the core 911 from the OTDR device 10. An optical repeater 930 is provided in the middle of the optical fiber 910. The optical repeater 930 includes an optical circuit guiding Rayleigh scattered light 902 generated by the monitoring light 901 to the core 912. The OTDR device 10 receives the Rayleigh scattered light 902 from the core 912 (a broken arrow). In this case, since the core 911 and the core 912 are in the same optical fiber 910, crosstalk light caused by the monitoring light 901 is superposed on the Rayleigh scattered light 902 by counter crosstalk in the optical fiber 910. Since the crosstalk light is noise to the Rayleigh scattered light, measurement precision may be degraded when the state of the optical fiber transmission channel 900 is measured by using the Rayleigh scattered light.

On the other hand, the optical fiber transmission channel 100 in FIG. 1 can guide the return light 103 to the second core 121 through the first coupling circuit 130 and can propagate the return light 103 through the second core 121 as the second light 102. Backscattered light generated by the first light 101 is an example of the return light 103. Then, the backscattered light may be Rayleigh scattered light. In other words, the OTDR device 10 can receive Rayleigh scattered light (the return light 103) from the second core 121 as the second light 102. Since the second core 121 is included in an optical fiber different from the first core 111, crosstalk between the first core 111 and the second core 121 is negligible. Accordingly, the optical fiber transmission channel 100 can reduce noise being caused by counter crosstalk and being superposed on Rayleigh scattered light compared with the common technology and therefore can improve precision in monitoring of the optical fiber transmission channel 100 using the OTDR device 10.

The second core 121 illustrated in FIG. 1 may be included in one single-core fiber. Alternatively, the second core 121 may be included in another multi-core fiber (a second multi-core fiber). The second multi-core fiber may be included in the optical fiber transmission channel 100. Furthermore, the optical fiber transmission channel 100 may include a second coupling circuit. The second coupling circuit couples light propagating through the second core 121 in a direction opposite to the second light 102 to the first core 111 in the direction of the first light 101. The first core 111, the second core 121, and the third core 112 may be housed in the same optical cable.

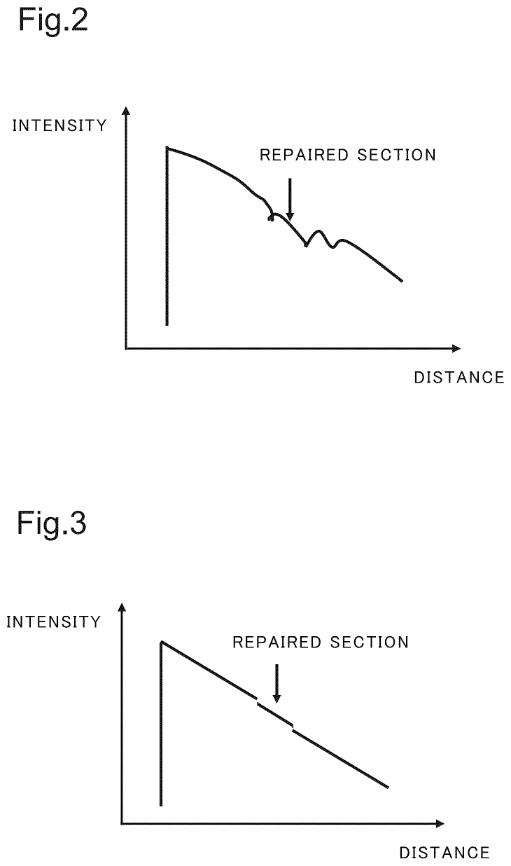

FIG. 2 is a diagram illustrating an example of a result of monitoring an optical fiber by using a common technology. The vertical axis indicates the intensity of Rayleigh scattered light, and the horizontal axis indicates the distance from an OTDR device. A fusion splice point caused by repair may exist in a long-distance optical fiber, and the fusion splice point is observed as a change point of the intensity of Rayleigh scattered light as a result of monitoring using the OTDR device. FIG. 2 illustrates that the intensity of Rayleigh scattered light changes according to the position in the optical fiber due to an effect of crosstalk. For example, FIG. 2 illustrates an example of an intensity change in Rayleigh scattered light being masked by the effect of crosstalk light even when a section repaired by fusion splicing exists at a position indicated by a downward arrow.

Such irregular intensity changes in Rayleigh scattered light may occur when the magnitude of counter crosstalk is uneven along a longitudinal direction of an optical fiber. The unevenness in counter crosstalk may also occur due to a bend or a twist at manufacture of the optical fiber or after laying the optical fiber. Furthermore, a long-distance optical fiber may be configured by connecting a plurality of optical fibers with different characteristics and/or structures in order to adjust optical characteristics such as dispersion. Such coexistence of different types of optical fibers may also cause the unevenness in crosstalk.

FIG. 3 is a diagram illustrating an example of a result of monitoring an optical fiber when an effect of counter crosstalk is negligible. Since the effect of counter crosstalk on Rayleigh scattered light in FIG. 3 is small, the intensity of the Rayleigh scattered light decreases almost linearly relative to the distance. Then, a fusion splice point is observed as a point where the intensity of the Rayleigh scattered light changes sharply compared with other sections.

Thus, in monitoring of an optical fiber using an OTDR device, precision in the monitoring of the optical fiber by the OTDR device can be improved by reducing an effect of crosstalk between a core through which monitoring light propagates and a core through which Rayleigh scattered light propagates.

### Second Example Embodiment

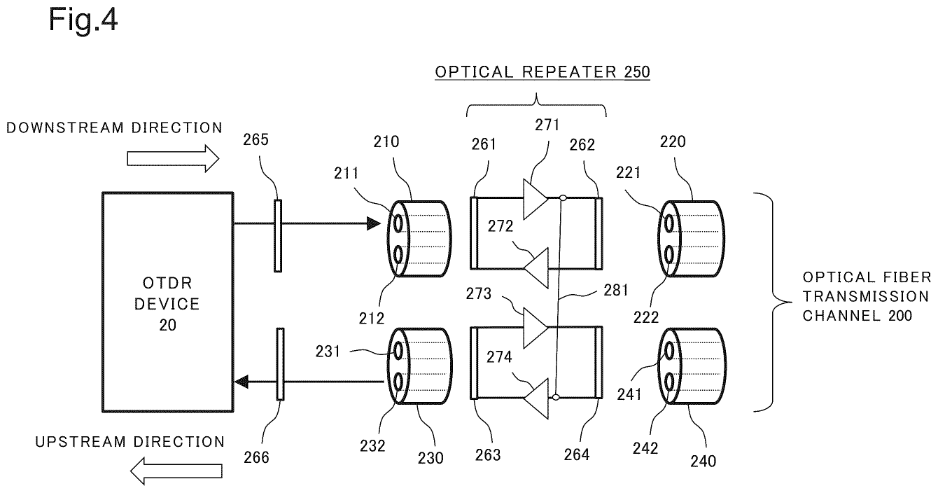

FIG. 4 is a diagram illustrating a configuration example of an optical fiber transmission channel 200 according to the present disclosure. The optical fiber transmission channel 200 includes optical fibers 210, 220, 230, and 240 and an optical repeater 250. The optical fiber 210 at least includes cores 211 and 212, and the core 211 and the core 212 constitute one core pair. A core pair (CP) is acquired by selecting and allocating two cores out of a plurality of cores included in an MCF. A core pair in a two-core MCF is also called a fiber pair (FP). Each of the optical fibers 220, 230, and 240 also at least includes two cores similarly to the optical fiber 210, and the cores constitute one core pair. A reference sign of each component in the optical fibers 220, 230, and 240 is assigned in the same way as that in the optical fiber 210. In this diagram, a direction from the left-hand side to the right-hand side of the page is called “downstream,” and a direction opposite to “downstream” is called “upstream.” For example, light propagating in the downstream direction is described as “downstream light.” The optical fiber transmission channel 200 is connected to an OTDR device 20 through fan-in/fan-outs (FIFOs) 265 and 266. A FIFO is a known optical component connecting a multi-core fiber to a single-core fiber.

An optical path inside the optical repeater 250 is routed by a single-core fiber. Therefore, FIFOs 261 to 264 are provided between the inside of the optical repeater 250 and the optical fibers 210, 220, 230, and 240, respectively. The FIFOs 261 to 264 may be provided in the optical repeater 250. Illustration of optical paths connected to the FIFOs is omitted in FIG. 4 and drawings after FIG. 4.

The optical repeater 250 includes optical amplifiers 271 to 274. The optical amplifier 271 amplifies downstream light input from the core 211 and outputs the amplified light to a core 221. The optical amplifier 272 amplifies upstream light input from a core 222 and outputs the amplified light to the core 212. Similarly, the optical amplifier 273 amplifies downstream light input from a core 231 and outputs the amplified light to a core 241. The optical amplifier 274 amplifies upstream light input from a core 242 and outputs the amplified light to a core 232. Each of the optical amplifiers 271 to 274 is one form of a relay circuit relaying light propagating through a core.

The optical repeater 250 includes a coupling circuit 281 connecting the core 221 to the core 242. The coupling circuit 281 guides upstream light propagating through the core 221 from the output side of the optical amplifier 271 to the input side of the optical amplifier 274. The light propagating through the coupling circuit 281 is amplified by the optical amplifier 274 and propagates through the core 232 as upstream light. The coupling circuit 281 can be configured with optical couplers respectively provided on the output side of the optical amplifier 271 and the input side of the optical amplifier 274, and an optical path connecting the optical couplers. For example, the optical coupler is a 2-by-1 optical coupler or a 2-by-2 optical coupler. The optical coupler branches and couples input light. For example, the optical path may be configured by using a single-core fiber or an optical waveguide.

When monitoring light is input to the core 211 in the downstream direction by using the OTDR device 20 in the optical fiber transmission channel 200 with such a configuration, Rayleigh scattered light generated in the core 221 propagates through the core 221 in the upstream direction. Then, the Rayleigh scattered light is input to the optical amplifier 274 through the coupling circuit 281 and propagates through the core 232 in the upstream direction. The Rayleigh scattered light propagating through the core 232 is received by the OTDR device 20. The OTDR device 20 acquires the state of the core 221 by using the received Rayleigh scattered light. Since the Rayleigh scattered light generated in the core 221 propagates through the optical fiber 230 different from the core 211 and is received by the OTDR device 20, the Rayleigh scattered light is transmitted to the OTDR device 20 without being significantly affected by crosstalk caused by the monitoring light. Accordingly, the configuration of the optical fiber transmission channel 200 suppresses degradation in precision in monitoring of the core 221 by the OTDR device 20.

### First Modified Example of Second Example Embodiment

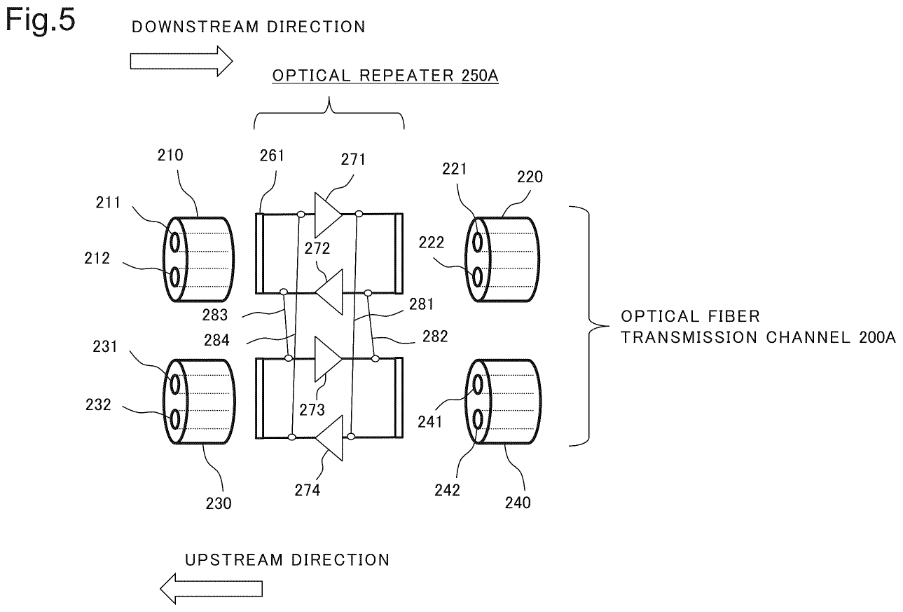

FIG. 5 is a diagram illustrating a configuration example of an optical fiber transmission channel 200A according to the present disclosure. The optical fiber transmission channel 200A includes an optical repeater 250A in place of the optical repeater 250 in the optical fiber transmission channel 200. The optical repeater 250A is a modified example of the optical repeater 250. The following description focuses on changes from the optical repeater 250 in the optical repeater 250A.

The optical repeater 250A includes coupling circuits 281 to 284. The coupling circuit 281 couples upstream light in the core 221 to an upstream optical path in the core 242 at the input of the optical amplifier 274.

The coupling circuit 282 couples upstream light in the core 241 to an upstream optical path in the core 212 at the input of the optical amplifier 272.

The coupling circuit 283 couples downstream light in the core 212 to a downstream direction optical path in the core 231 at the input of the optical amplifier 273.

The coupling circuit 284 couples downstream light in the core 232 to a downstream optical path in the core 221 at the input of the optical amplifier 271.

By including the coupling circuits 281 to 284, the optical repeater 250A can guide light traveling in a direction opposite to the amplified light to a core in another fiber in each of the cores to which light beams amplified by the optical amplifiers 271 to 274 are respectively input. For example, when monitoring light is input to the core 242 in the upstream direction, Rayleigh scattered light propagating in the downstream direction is generated in the core 232. The Rayleigh scattered light is guided to the input of the optical amplifier 271 through the coupling circuit 284. Then, the Rayleigh scattered light can be amplified by the optical amplifier 271 and be propagated as downstream light through the core 221. The Rayleigh scattered light in this case is transmitted without being affected by crosstalk caused by the monitoring light propagating through the core 242. Accordingly, the core 232 can be monitored by inputting monitoring light to the core 242 in the upstream direction and analyzing Rayleigh scattered light propagating through the core 221 in the downstream direction.

The core 212 or the core 241 can also be monitored by a similar action when monitoring light is input to the core 222 in the upstream direction or to the core 231 in the downstream direction, respectively. Accordingly, the optical repeater 250A and the optical fiber transmission channel 200A incorporating the optical repeater 250A in place of the optical repeater 250 can suppress degradation in monitoring precision using an OTDR device.

### Second Modified Example of Second Example Embodiment

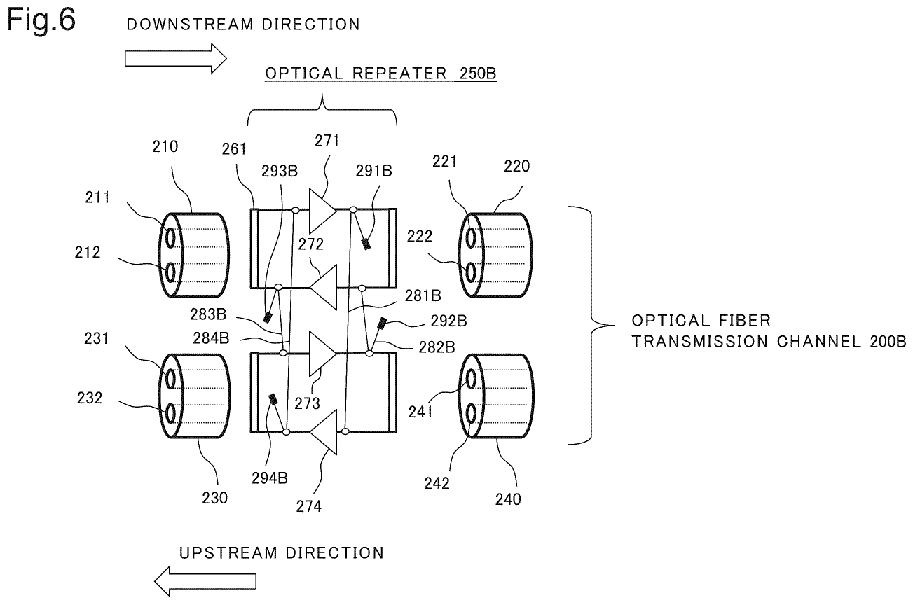

FIG. 6 is a diagram illustrating a configuration example of an optical fiber transmission channel 200B according to the present disclosure. The optical fiber transmission channel 200B includes an optical repeater 250B. The optical repeater 250B is a modified example of the optical repeater 250A. The following description about the optical repeater 250B focuses on changes from the optical repeater 250A.

The optical repeater 250B includes coupling circuits 281B to 284B. Each of the coupling circuits 281B to 284B reflects input light and propagates the light in the opposite direction. The coupling circuits 281B to 284B include reflectors 291B to 294B, respectively.

The reflector 291B reflects part or all of input light. The reflector 291B according to the present example embodiment is configured to reflect part of light output from the optical amplifier 271 and guide the light to the coupling circuit 281. The same holds for the reflectors 292B to 294B. The reflectors 291B to 294B may be respectively placed at ends of 2-by-2 optical couplers respectively constituting the coupling circuits 281B to 284B. In this case, part of light beams output from the optical amplifiers 271 to 274 respectively enter the reflectors 291B to 294B and are reflected through the 2-by-2 optical couplers. The reflected light beams are respectively input to the coupling circuits 281B to 284B through the 2-by-2 optical couplers.

Each of the reflectors 291B to 294B may selectively reflect light beams at part of wavelengths in transmitted light beams. For example, each of the reflectors 291B to 294B may reflect light including a control signal used for monitoring and controlling the optical repeater 250 (control light) in the optical fiber transmission channel 200B. The control light is looped back to a core connected to each of the coupling circuits 281 to 284 through the coupling circuit. The looped back control light is received by a monitoring-control device at a terminal station. The monitoring-control device monitors the state of the optical fiber transmission channel 200 by using reflected light input from one of the reflectors 291B to 294B. An OTDR device connected to the optical fiber transmission channel 200 may have the function of the monitoring-control device.

### Third Example Embodiment

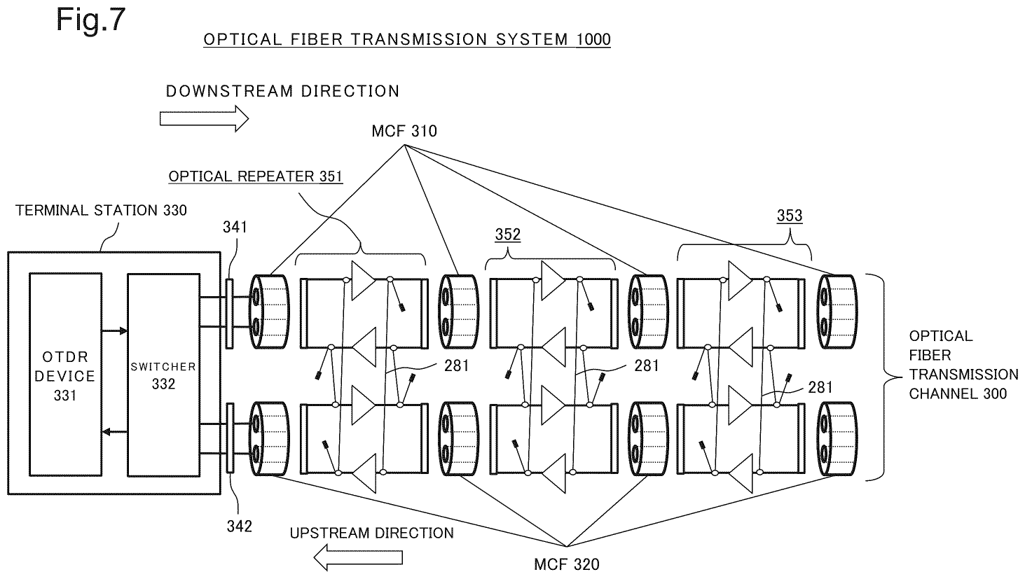

FIG. 7 is a diagram illustrating a configuration example of an optical fiber transmission system 1000 according to the present disclosure. The optical fiber transmission system 1000 includes an optical fiber transmission channel 300 and a terminal station 330. The optical fiber transmission channel 300 includes two-core MCFs 310 and 320 and optical repeaters 351 to 353. FIFOs 341 and 342 are placed between the terminal station 330 and the MCFs 310 and 320, respectively. The optical repeaters 351 to 353 have the same configuration. Therefore, when being collectively referred to, the optical repeaters 351 to 353 may be described as optical repeaters 350. The optical fiber transmission channel 300 has a configuration acquired by cascade-connecting the optical fiber transmission channels 200B illustrated in FIG. 6. In other words, the MCF 310 includes the optical fibers 210 and 220 in FIG. 6, and the MCF 320 includes the optical fibers 230 and 240 in FIG. 4. One of the optical repeaters 250, 250A, and 250B in FIGS. 4 to 6 may be used as the optical repeater 350.

The terminal station 330 includes an OTDR device 331 and a switcher 332. The OTDR device 331 outputs monitoring light to the switcher 332. Rayleigh scattered light generated by the monitoring light in the optical fiber transmission channel 300 is input to the OTDR device 331 from the switcher 332. The OTDR device 331 monitors the state of a core through which the monitoring light propagates by analyzing the received Rayleigh scattered light.

The switcher 332 connects the OTDR device 331 to the cores of the MCF 310 and the cores of the MCF 320. The switcher 332 independently selects one core to which the OTDR device 331 transmits monitoring light and one core from which the OTDR device 331 receives Rayleigh scattered light. The OTDR device 331 and the switcher 332 may be operated by maintenance personnel working at the terminal station or may be controlled by a monitoring system at a remote location.

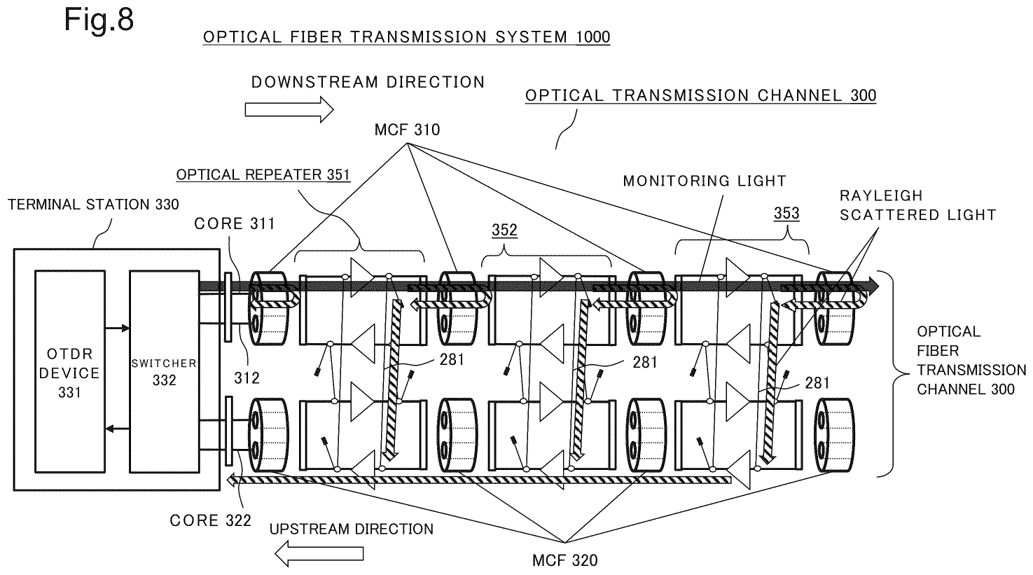

FIG. 8 is a diagram illustrating an example of propagation of monitoring light and Rayleigh scattered light in the optical fiber transmission system 1000 according to the present disclosure. In FIG. 8, the switcher 332 is set in such a way that monitoring light output from the OTDR device 331 is input to a core 311 of the MCF 310. The switcher 332 is also set in such a way as to receive Rayleigh scattered light from a core 322 of the MCF 320. In such a configuration, upstream Rayleigh scattered light generated by the monitoring light propagating through the MCF 310 in the downstream direction is guided to the core 322 of the MCF 320 through a coupling circuit 281 provided in each of the optical repeaters 351 to 353. The Rayleigh scattered light propagating through the core 322 in the upstream direction is received by the OTDR device 331 through the switcher 332. The coupling circuit 281 provided in each optical repeater does not connect the core 311 to a core 312 and connects the core 311 to the core 322. Accordingly, the Rayleigh scattered light generated by the monitoring light propagating through the core 311 is guided to the core 322 without propagating through the core 312. As a result, the OTDR device 331 can monitor the core 311 by analyzing the Rayleigh scattered light propagating through the core 322.

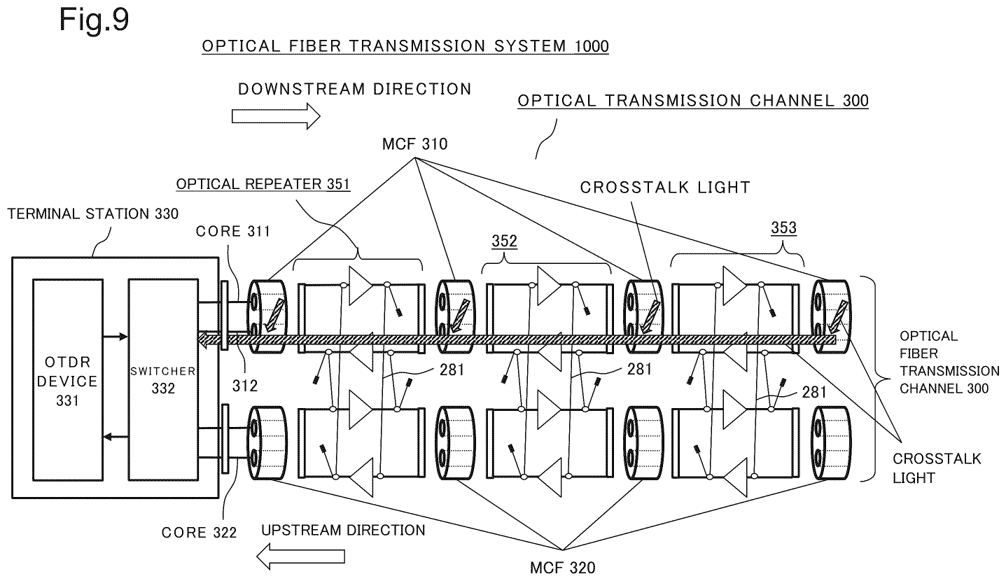

FIG. 9 is a diagram illustrating an example of propagation of crosstalk light in the optical fiber transmission system 1000 according to the present disclosure. The connection between the OTDR device 331 and the optical fiber transmission channel 300 in FIG. 9 is similar to that in FIG. 8. In FIG. 9, counter crosstalk light generated for monitoring light propagating through the core 311 of the MCF 310 in the downstream direction propagates through the core 312 adjacent to the core 311. However, since the core 322 is in an optical fiber different from the cores 311 and 312, crosstalk does not occur between the core 312 and the core 322. Further, the coupling circuit 281 does not connect between the cores. Accordingly, upstream crosstalk light propagating through the core 312 does not affect Rayleigh scattered light propagating through the core 322. Accordingly, the optical fiber transmission system 1000 can suppress degradation in monitoring precision caused by crosstalk light when Rayleigh scattered light propagating through the core 322 is analyzed.

### Fourth Example Embodiment

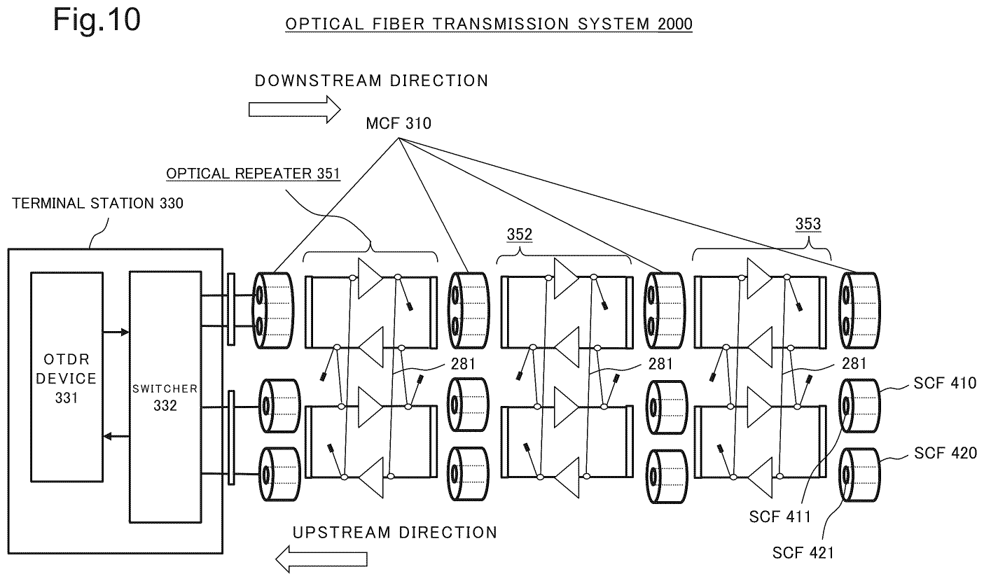

FIG. 10 is a diagram illustrating a configuration example of an optical fiber transmission system 2000 according to the present disclosure. The optical fiber transmission system 2000 includes single-core fibers (SCFs) 410 and 420 in place of the MCF 320 included in the optical fiber transmission system 1000. An SCF is an optical fiber including only one core. A core 411 of the SCF 410 and a core 421 of the SCF 420 are related to the core 321 and the core 322 included in the optical fiber transmission system 1000, respectively.

In each optical repeater 250, a coupling circuit 281 connects the core 311 of the MCF 310 to the core 421 of the SCF 420, similarly to FIG. 8. The core 312 is not connected to the core 421. Accordingly, an OTDR device 331 in the optical fiber transmission system 2000 can monitor the core 311 by analyzing Rayleigh scattered light propagating through the core 421. Further, the optical fiber transmission system 2000 can suppress degradation in monitoring precision caused by crosstalk light when Rayleigh scattered light propagating through the core 421 is analyzed.

### Fifth Example Embodiment

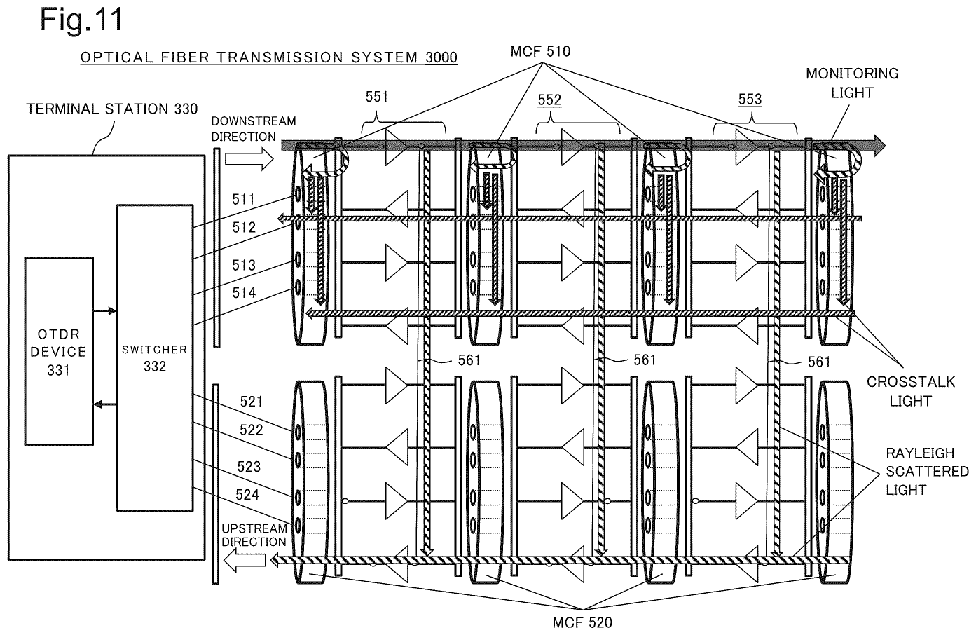

FIG. 11 is a diagram illustrating a configuration example of an optical fiber transmission system 3000 according to the present disclosure. The optical fiber transmission system 3000 includes MCFs 510 and 520 in place of the MCFs 310 and 320 included in the optical fiber transmission system 1000. Each of the MCFs 510 and 520 is a four-core MCF. The MCF 510 includes cores 511 to 514, and the MCF 520 includes cores 521 to 524. The cores 511 and 512 constitute one core pair, and the cores 513 and 514 constitute one core pair. Similarly, the cores 521 and 522 constitute one core pair, and the cores 523 and 524 constitute one core pair. Each of optical repeaters 551 to 553 amplifies light beams propagating through two cores constituting one core pair. Each of the optical repeaters 551 to 553 amplifies light beams propagating through two cores in one core pair in directions opposite to each other.

A coupling circuit 561 in each of the optical repeaters 551 to 553 connects the core 511 of the MCF 510 to the core 524 of the MCF 520.

Since the MCF 510 is a four-core MCF, Rayleigh scattered light generated in the core 511 also propagates through the cores 512 to 514 by crosstalk inside the MCF 510. However, since the cores 512 to 514 are not connected to the core 524, crosstalk light beams propagating through the cores 512 to 514 do not affect light propagating through the core 524. In particular, Rayleigh scattered light leaking into the core 513 from the core 511 by crosstalk is blocked by optical isolators provided at the outputs of respective optical amplifiers in the optical repeaters 551 to 553. In other words, Rayleigh scattered light leaking into the core 513 is blocked by the closest optical repeater.

Thus, an OTDR device 331 can monitor the core 511 by analyzing Rayleigh scattered light propagating through the core 524 in the optical fiber transmission system 3000 as well. Then, the optical fiber transmission system 3000 can suppress degradation in monitoring precision caused by crosstalk light when Rayleigh scattered light propagating through the core 524 is analyzed.

The example embodiments according to the present disclosure may also be described as, but not limited to, the following Supplementary Notes.

### Supplementary Note 1

An optical fiber transmission channel including:
a first optical fiber configured to include a plurality of cores sharing a clad;
a second optical fiber configured not to share a clad with the first optical fiber; and
a first coupling circuit configured to couple a core of the first optical fiber to a core of the second optical fiber, wherein
the coupling circuit couples return light of first light propagating through a core of the first optical fiber to a core of the second optical fiber as second light.

### Supplementary Note 2

The optical fiber transmission channel according to Supplementary Note 1, wherein
the return light is light generated by the first light being backscattered or reflected.

### Supplementary Note 3

The optical fiber transmission channel according to Supplementary Note 1 or 2, wherein
the coupling circuit connects the first optical fiber to the second optical fiber in such a way as to suppress crosstalk between the first light and the return light between a plurality of cores in the first optical fiber.

### Supplementary Note 4

The optical fiber transmission channel according to Supplementary Note 1 or 2, wherein
a communication method for suppressing crosstalk between signal light beams between a plurality of cores in the first optical fiber is used.

### Supplementary Note 5

The optical fiber transmission channel according to Supplementary Note 4, wherein
the communication method includes a method of causing counter transmission of signal light beams in the first optical fiber.

### Supplementary Note 6

The optical fiber transmission channel according to any one of Supplementary Notes 1 to 5, wherein
the first light is monitoring light for monitoring a state of the optical fiber transmission channel.

### Supplementary Note 7

The optical fiber transmission channel according to any one of Supplementary Notes 1 to 6, wherein
the second optical fiber is a multi-core fiber.

### Supplementary Note 8

The optical fiber transmission channel according to any one of Supplementary Notes 1 to 6, wherein
the second optical fiber is a single-core fiber.

### Supplementary Note 9

The optical fiber transmission channel according to any one of Supplementary Notes 1 to 8, wherein
the coupling circuit includes an optical coupler and a reflector, and
the optical coupler branches the first light, guides the branched first light to the reflector, and couples the return light being the first light reflected off the reflector to the second optical fiber as the second light.

### Supplementary Note 10

The optical fiber transmission channel according to any one of Supplementary Notes 1 to 8, further including
a second coupling circuit configured to couple light propagating through a core of the second optical fiber in a direction opposite to the second light to the first optical fiber in a direction of the first light.

### Supplementary Note 11

The optical fiber transmission channel according to any one of Supplementary Notes 1 to 10, wherein
the first optical fiber and the second optical fiber are provided in one optical cable.

### Supplementary Note 12

The optical fiber transmission channel according to any one of Supplementary Notes 1 to 11, further including
an optical repeater including a relay circuit relaying the first light and the second light and the first coupling circuit.

### Supplementary Note 13

An optical fiber transmission system including: an optical fiber transmission channel; and an optical time-domain reflectometer (OTDR) device, wherein
the optical fiber transmission channel includes:
   a first optical fiber configured to include a plurality of cores sharing a clad;
   a second optical fiber configured not to share a clad with the first optical fiber; and
   a first coupling circuit configured to couple a core of the first optical fiber to a core of the second optical fiber,
the coupling circuit couples return light of first light propagating through a core of the first optical fiber to a core of the second optical fiber as second light, and
the OTDR device transmits the first light to the first optical fiber and receives the second light from the second optical fiber.

### Supplementary Note 14

The optical fiber transmission system according to Supplementary Note 13, wherein
the return light is light generated by the first light being backscattered or reflected.

### Supplementary Note 15

An optical transmission method used in an optical fiber transmission channel including: a first optical fiber configured to include a plurality of cores sharing a clad; and a second optical fiber configured not to share a clad with the first optical fiber, the optical transmission method including
coupling return light of first light propagating through a core of the first optical fiber to a core of the second optical fiber as second light.

### Supplementary Note 16

The optical transmission method according to Supplementary Note 15, wherein
the return light is light generated by the first light being backscattered or reflected.

### Supplementary Note 17

The optical transmission method according to Supplementary Note 15 or 16, further including
connecting the first optical fiber to the second optical fiber in such a way as to suppress crosstalk between the first light and the return light between a plurality of cores in the first optical fiber.

### Supplementary Note 18

The optical transmission method according to any one of Supplementary Notes 15 to 17, further including
using a communication method for suppressing crosstalk between signal light beams between a plurality of cores in the first optical fiber.

### Supplementary Note 19

The optical transmission method according to Supplementary Note 18, wherein
the communication method includes a method of causing counter transmission of signal light beams in the first optical fiber.

### Supplementary Note 20

The optical transmission method according to any one of Supplementary Notes 15 to 19, wherein
the first light is monitoring light for monitoring a state of the optical fiber transmission channel.

### Supplementary Note 21

The optical transmission method according to any one of Supplementary Notes 15 to 20, wherein
the second optical fiber is a multi-core fiber.

### Supplementary Note 22

The optical transmission method according to any one of Supplementary Notes 15 to 20, wherein
the second optical fiber is a single-core fiber.

### Supplementary Note 23

The optical transmission method according to any one of Supplementary Notes 15 to 22, further including
coupling light propagating through a core of the second optical fiber in a direction opposite to the second light to the first optical fiber in a direction of the first light.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims. For example, the optical fiber transmission system described in each example embodiment also discloses an optical transmission method applicable to an MCF transmission system.

The configurations described in the example embodiments are not necessarily exclusive to each other. The advantageous effects of the present disclosure may be provided by configurations acquired by combining the whole or a part of the aforementioned example embodiments.

1. An optical fiber transmission channel comprising:
a first optical fiber configured to include a plurality of cores sharing a clad;
a second optical fiber configured not to share a clad with the first optical fiber; and
a first coupling circuit configured to couple a core of the first optical fiber to a core of the second optical fiber, wherein
the coupling circuit couples return light of first light propagating through a core of the first optical fiber to a core of the second optical fiber as second light.

2. The optical fiber transmission channel according to claim 1, wherein
the return light is light generated by the first light being backscattered or reflected.

3. The optical fiber transmission channel according to claim 1, wherein
the coupling circuit connects the first optical fiber to the second optical fiber in such a way as to suppress crosstalk between the first light and the return light between a plurality of cores in the first optical fiber.

4. The optical fiber transmission channel according to claim 1, wherein
a communication method for suppressing crosstalk between signal light beams between a plurality of cores in the first optical fiber is used.

5. The optical fiber transmission channel according to claim 4, wherein
the communication method includes a method of causing counter transmission of signal light beams in the first optical fiber.

6. The optical fiber transmission channel according to claim 1, wherein
the first light is monitoring light for monitoring a state of the optical fiber transmission channel.

7. The optical fiber transmission channel according to claim 1, wherein
the second optical fiber is a multi-core fiber.

8. The optical fiber transmission channel according to claim 1, wherein
the second optical fiber is a single-core fiber.

9. The optical fiber transmission channel according to claim 1, wherein
the coupling circuit includes an optical coupler and a reflector, and
the optical coupler branches the first light, guides the branched first light to the reflector, and couples the return light being the first light reflected off the reflector to the second optical fiber as the second light.

10. The optical fiber transmission channel according to claim 1, further comprising
a second coupling circuit configured to couple light propagating through a core of the second optical fiber in a direction opposite to the second light to the first optical fiber in a direction of the first light.

11. The optical fiber transmission channel according to claim 1, wherein
the first optical fiber and the second optical fiber are provided in one optical cable.

12. The optical fiber transmission channel according to claim 1, further comprising
an optical repeater including a relay circuit relaying the first light and the second light, and the first coupling circuit.

13. An optical fiber transmission system comprising: an optical fiber transmission channel; and an optical time-domain reflectometer (OTDR) device, wherein
the optical fiber transmission channel includes:
a first optical fiber configured to include a plurality of cores sharing a clad;
a second optical fiber configured not to share a clad with the first optical fiber; and
a first coupling circuit configured to couple a core of the first optical fiber to a core of the second optical fiber,
the coupling circuit couples return light of first light propagating through a core of the first optical fiber to a core of the second optical fiber as second light, and
the OTDR device transmits the first light to the first optical fiber and receives the second light from the second optical fiber.

14. The optical fiber transmission system according to claim 13, wherein
the return light is light generated by the first light being backscattered or reflected.

15. An optical transmission method used in an optical fiber transmission channel including: a first optical fiber configured to include a plurality of cores sharing a clad; a second optical fiber configured not to share a clad with the first optical fiber; and a first coupling circuit configured to couple a core of the first optical fiber to a core of the second optical fiber, the optical transmission method comprising
coupling return light of first light propagating through a core of the first optical fiber to a core of the second optical fiber as second light by the first coupling circuit.

16. The optical transmission method according to claim 15, wherein
the return light is light generated by the first light being backscattered or reflected.

17. The optical transmission method according to claim 15, further comprising
connecting the first optical fiber to the second optical fiber in such a way as to suppress crosstalk between the first light and the return light between a plurality of cores in the first optical fiber.

18. The optical transmission method according to claim 15, further comprising
using a communication method for suppressing crosstalk between signal light beams between a plurality of cores in the first optical fiber.

19. The optical transmission method according to claim 18, wherein
the communication method includes a method of causing counter transmission of signal light beams in the first optical fiber.

20. The optical transmission method according to claim 15, wherein
the first light is monitoring light for monitoring a state of the optical fiber transmission channel.
